(19) United States
(12) Patent Application Publication
(10) Pub. No.: US 2024/0278676 A1
(43) Pub. Date: Aug. 22, 2024

(54) CHARGING SYSTEM FOR VEHICLE EQUIPPED WITH BATTERY, VEHICLE, AND SERVER

(71) Applicant: TOYOTA JIDOSHA KABUSHIKI KAISHA, Toyota-shi (JP)

(72) Inventor: Yasuo SUZUKI, Nagoya-shi (JP)

(73) Assignee: TOYOTA JIDOSHA KABUSHIKI KAISHA, Toyota-shi (JP)

(21) Appl. No.: 18/534,898

(22) Filed: Dec. 11, 2023

(30) Foreign Application Priority Data
Feb. 21, 2023 (JP) 2023-025330

(51) Int. Cl. B60L 53/66; B60L 53/62; B60L 53/68

(52) U.S. Cl. CPC B60L 53/66; B60L 53/62; B60L 53/68

(57) ABSTRACT

A charging system for a vehicle equipped with a battery includes a first vehicle, a second vehicle, and a server, wherein the first vehicle is one of a plurality of chargers arranged to charge the battery. The charger acquires power supply information regarding the power supply status of the power supplied to the first vehicle and transmits the power supply information to the server, and the server determines the soundness of the charger based on the power supply information received from the first vehicle, to provide health information regarding the health of the charger to the user of the first vehicle and/or the second vehicle.

### CROSS-REFERENCE TO RELATED APPLICATION

This application claims priority to Japanese Patent Application No. 2023-025330 filed on Feb. 21, 2023, incorporated herein by reference in its entirety.

### BACKGROUND

### 1. Technical Field

A technique disclosed in the present specification relates to, for example, a charging system for a vehicle, the vehicle, and a server.

### 2. Description of Related Art

In a vehicle equipped with a battery, it is possible to charge the battery by receiving power supplied from a charger installed as a charging stand installed outside the vehicle. In such a vehicle, the battery can be charged only with a charger that complies with predetermined charging standards. For this reason, it has been disclosed to provide a user of the vehicle with information about the charger that complies with the charging standards (Japanese Unexamined Patent Application Publication No. 2020-108244 (JP 2020-108244 A)).

### SUMMARY

However, when a failure occurs in the charger even if the charger complies with the charging standards, the charging from the charging facility may not be sufficient, or a failure may be caused in a power receiving unit of the vehicle.

The present specification provides a technique for avoiding deterioration of charging convenience due to the failure of the charger.

The technique disclosed in the present specification is embodied in a charging system for a vehicle equipped with a battery.

The charging system includes a first vehicle, a second vehicle, and a server.

The first vehicle acquires power supply information about a power supply status of power supplied to the first vehicle by at least one charger of a plurality of chargers, and transmits the power supply information to the server.

The server determines health of the at least one charger based on the power supply information received from the first vehicle, and provides health information about the health of the at least one charger to a user of the first vehicle or the second vehicle, or users of the first vehicle and the second vehicle.

According to such a charging system, the server can hold the health information about the charger, and the health information is available to the user of the first vehicle or the second vehicle, or the users of the first vehicle and the second vehicle. As a result, the user can perform safer and more reliable charging. As a result, the user's convenience regarding the external charging is improved.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing an example of a charging system;

FIG. 2A is a diagram illustrating an example of a charger determination and management process implemented by a server in a charging system;

FIG. 2B is a diagram illustrating another example of a charger determination and management process performed by a server in a charging system;

FIG. 3 is a diagram showing an example of a process of using charger health information performed by a vehicle in a charging system; and

FIG. 4 is a diagram illustrating another example of the power receiving unit determination and management process performed by the server in the charging system.

### DETAILED DESCRIPTION OF EMBODIMENTS

One embodiment disclosed herein is a charging system for a vehicle equipped with a battery, comprising a first vehicle, a second vehicle, and a server, wherein the first vehicle carries a battery. At least one charger out of a plurality of chargers arranged for charging acquires power supply information regarding the power supply status of power to be supplied to the first vehicle, and transmits the power supply information to the server, wherein the server determining the health of the at least one charger based on the power supply information received from the first vehicle, and transmitting health information about the health of the at least one charger to the first vehicle and/or to the user of the second vehicle;

In the above embodiments disclosed herein, the health information may include location information of the at least one charger. Accompanying the location information of the charger improves convenience for the user of the first vehicle and/or the second vehicle.

In the above embodiments of the present disclosure, the server may determine a health level for the at least one charger based on power supply information of the at least one charger. By doing so, the health of the charger can be determined with higher accuracy, and more practical health information can be provided to the user of the first vehicle and/or the second vehicle.

In the above embodiments of the present disclosure, the server may determine a level of health for the at least one charger based on historical power supply information of the at least one charger. By doing so, the health of the charger can be determined with higher accuracy, and more practical health information can be provided to the user of the first vehicle and/or the second vehicle.

In the above embodiments of the present disclosure, the server provides the user with the health information including usage information regarding usage of the at least one charger based on the health level of the at least one charger. By doing so, the user of the first vehicle and/or the second vehicle can easily decide whether or not to use the charger.

An embodiment of the present disclosure is a vehicle that includes a battery that can be charged by a charger, and a sensor that detects power supply information about a power supply status of power supplied to a vehicle by the charger, and that is configured to transmit the power supply information to a server.

In the above embodiment of the present disclosure, the server determines the health of the charger based on the power supply information received from the vehicle, and sends the health information about the health of the charger to the vehicle and/or other may be provided to the user of the vehicle. Further, in the above embodiment of the present disclosure, the vehicle may receive from the server the health information regarding the health of the other charger based on the power supply information of the other charger received by the server from the other vehicle.

An embodiment of the present disclosure is a server that transmits and receives information to and from a first vehicle and a second vehicle, the first vehicle and the second vehicle are vehicles whose batteries are charged by chargers, in which receiving, from the first vehicle, power supply information relating to the power supply status of power supplied to the first vehicle by at least one charger capable of charging the battery; and based on the power supply information, determining the health of the at least one charger and providing health information regarding the health of the at least one charger to a user of the first vehicle and/or the second vehicle.

With such a vehicle and server, the user of the vehicle can acquire the health information of the charger determined by the server, so convenience for the user of the vehicle during charging is improved.

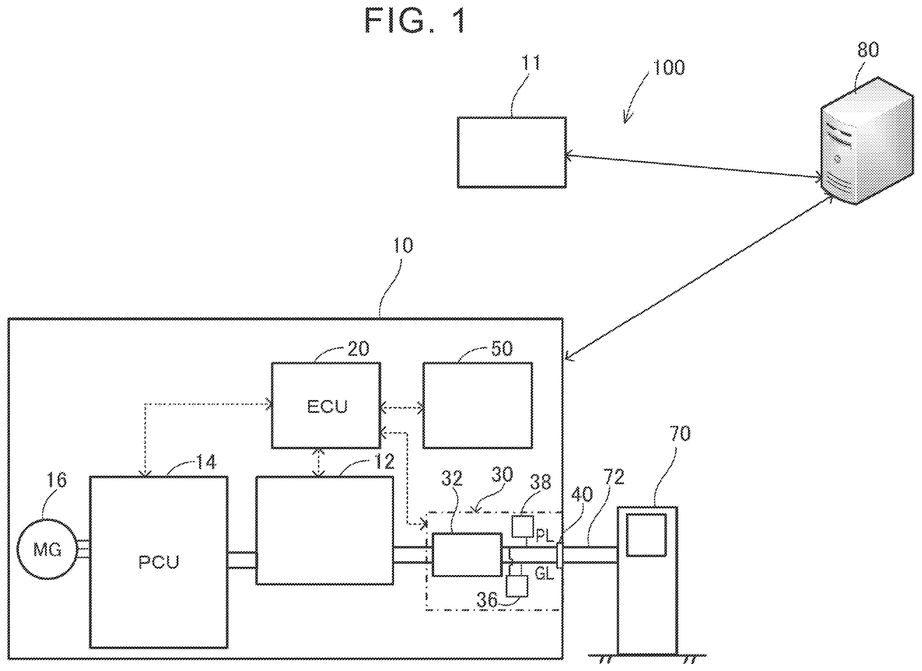

Hereinafter, the vehicle charging system disclosed in this specification will be described with reference to the drawings as appropriate. FIG. 1 is a diagram showing an example of a charging system.

A charging system 100 shown in FIG. 1 includes a vehicle 2 of a certain user, a vehicle 4 of another user, and a server 80. Both vehicles 10 and 11 are, for example, battery electric vehicles on which batteries 12 are mounted. Further, charging system 100 may include multiple vehicles other than vehicles 2,4. The charging system 100 relates to the use of a charger 70 located external to the vehicle 10,11, but to the use of multiple chargers other than the charger 70.

Vehicles 10 and 11 are both configured to be capable of “external charging” in which battery 12 is charged with electric power supplied from charger 70. The vehicle 10 has at least the same configuration for external charging. In the following description, when describing the same configuration of the vehicles 10 and 11, they are collectively referred to as the vehicle 10 and the like. The vehicle 10 and the like can be connected to the charger 70 by wire via a charging cable 72. Note that the vehicle 10 or the like may be configured to be externally chargeable, and may be a plug-in hybrid electric vehicle, a fuel cell electric vehicle, or the like.

A vehicle 10 or the like includes a battery 12, a power control unit (PCU) 14, a motor generator (MG) 16 and an Electronic Control Unit (ECU) 20.

### Battery

The battery 12 is a rechargeable power storage device, and includes a secondary battery such as a lithium-ion secondary battery or a nickel metal hydride battery. The battery 12 supplies electric power to the PCU 14 to generate driving force for running the vehicle 10. Also, the battery 12 is charged by power generated by regenerative braking of the MG 16 or by power supplied from the charger 70. Note that a capacitor such as an electric double layer capacitor may be employed instead of the battery 12.

The battery 12 has a voltage sensor, a current sensor, and a temperature sensor (not shown), and outputs the detection results of these sensors to the ECU 20. The ECU 20 calculates the SOC of the battery 12 based on these detection results.

### PCU

The PCU 14 is a power conversion device that is connected to the battery 12 and performs power conversion between the battery 12 and the MG 16 according to commands from the ECU 20. The PCU 14 includes an inverter that receives power from the battery 12 to drive the MG 16, a converter that adjusts the level of the DC voltage supplied to the inverter (both not shown), and the like.

### MG

MG 16 is an AC motor, for example, a permanent magnet type synchronous motor with a rotor (not shown) in which permanent magnets are embedded. MG 16 is driven by an inverter contained in PCU 14 to rotate a drive shaft (not shown). In addition, the MG 16 receives the rotational force of the drive wheels to generate power when braking the vehicle, and charges the battery 12 through the PCU 14.

### ECU

The ECU 20 includes a CPU, a memory, input/output ports for inputting/outputting various signals, and the like. The ECU 20 controls each device (the PCU 14, various relays, the DC/DC converter 32, etc.) in the vehicle 10 and the like so that the vehicle 10 and the like is in a desired state. In addition, the ECU 20 transmits various information (such as position information of the vehicle 10 and the like) to the server 80 and receives information from the server 80 via the communication device 50 which will be described later. The ECU 20 may be a higher control unit itself instead of an ECU, or may be under the control of a higher control unit.

When the vehicle 10 or the like is connected to the charger 70, the ECU 20 acquires and stores the power supply information regarding the power supply status such as data regarding the voltage waveform of the power supplied from the charger 70 supplied to the power receiving unit 30, waveform data such as peak value, amplitude, and frequency, and current data, transmits the power supply information to the server 80 via the communication device 50 to request the server 80 to execute the soundness determination process of the charger 70.

The ECU 20 also implements a process for providing health information of the charger 70 to a user of the vehicle 10 or the like prior to the battery 12 falling in SOC and requiring charging. Specifically, the ECU 20 obtains from the server 80 health information of several chargers, including the chargers 70 within a travelable distance range from the current position of the vehicle 10 or the like, and informs the user of these charging conditions. Provides instrument health information.

### Power Receiving Part

The vehicle 10 or the like includes a power receiving unit 30 as a configuration of a vehicle that includes the battery 12 and can be externally charged. Power reception unit 30 includes DC/DC converter 32, voltage sensor 36, current sensor 38, power lines PL and GL, and inlet 40.

When charging battery 12, connector 74 of charging cable 72 is connected to inlet 40. Electric power supplied from charger 70 is supplied to vehicle 10 and the like through a power line in charging cable 72. The power is further transmitted to DC/DC converter 32 of power receiving unit 30 through power lines PL and GL. DC/DC converter 32 converts the electric power supplied from charger 70 into electric power for charging battery 12 according to a command from ECU 20. DC/DC converter 32 may be configured to convert electric power from battery 12 into electric power for outputting to the outside of the vehicle.

Between the DC/DC converter 32 and the battery 12, a charge relay or the like is closed by a command from the ECU 20, and power transmission between the inlet 40 and the battery 12 becomes possible.

Voltage sensor 36 is electrically connected between power line PL and power line GL. The voltage sensor 36 detects the voltage, waveform, wave height, frequency, etc. of the power supplied from the charger 70 to the DC/DC converter 32 when the charger 70 and the vehicle 10 or the like are connected, and outputs the detection result to the ECU 20.

Current sensor 38 is electrically connected to power line PL. Current sensor 38 detects the current flowing from charger 70 to DC/DC converter 32 when charger 70 and vehicle 10 or the like are connected, and outputs the detection result to ECU 20.

### Communication Device

The vehicle 10 and the like further includes a communication device 50 via a dedicated communication line as a configuration for communicating with a server 80 outside the vehicle for transmitting and receiving information. The communication device 50 and the ECU 20 are connected to each other via a wired in-vehicle network or the like, and are configured to be able to communicate with each other. The communication device 50 may be capable of transmitting/receiving data to/from a user's mobile terminal such as the vehicle 10, or may be separately equipped with a communication device for such a mobile terminal. Also, the vehicle 10 and the like may be separately provided with a communication device for transmitting and receiving information via an Internet line. Those skilled in the art can appropriately design and acquire such various communication devices according to their purposes.

The vehicle 10 or the like further includes a GPS receiver that identifies the current location of the vehicle 10 or the like based on radio waves from artificial satellites. The position information (GPS information) of the current location of the vehicle 10 or the like is acquired by the GPS receiver, and the acquired position information is transmitted to the server 80. In addition, using the position information, various information such as the current position of the vehicle 10, the travel route, the target position, and the position information of many chargers including the charger 70 are displayed on the display of the navigation system provided in the vehicle 10, etc. can be displayed according to the running condition of the vehicle 10 or the like and the SOC of the battery 12.

### Charger

The charger 70 is, for example, a rapid charger installed at a public charging station (also called charging spot, charging station, etc.). Charger 70 is configured to convert AC power (for example, a three-phase 200 V power supply) supplied from a commercial power source into DC power and supply the DC power to vehicle 10. Note that the charger 70 is not particularly limited, and may be wireless charging, and includes various known charger modes. The mode of power receiving unit 30 of vehicle 10 is appropriately changed depending on the mode of charger 70.

The charger 70 has a charging cable 72 and is connected via a connector 74 to an inlet 40 provided in the vehicle 10 or the like. The charging cable 72 includes a power line 76, a signal line, and the like.

### Server

The server 80 functions as a computer that receives requests from other computers such as the ECU 20 provided in the vehicle 10 and returns information and processing results. The server 80 is configured to be able to communicate with the communication devices 50 of many vehicles including the vehicle 10 and the like. Server 80 manages power supply information of a number of chargers including charger 70 (hereinafter simply referred to as charger 70 and the like) received from vehicle 10 and the like. Further, the server 80 manages the health information of the charger as a determination result regarding the health of the charger 70 and the like based on the power supply information. The server 80 exchanges the health information of the charger 70 and the like with the vehicle 10 and the like as necessary.

The server 80 acquires, from the ECU 20, the voltage waveform of the power supplied from the charger 70, etc., and the power supply information regarding the power supply status, such as current, and determines the soundness of the charger 70, etc. and performs a management process. Further, the server 80 executes a process of providing soundness information of the charger 70 and the like to the ECU 20 of the vehicle 10 and the like in response to a request from the ECU 20 of the vehicle 10 and the like. In the following description, the detailed steps performed by server 80 are described.

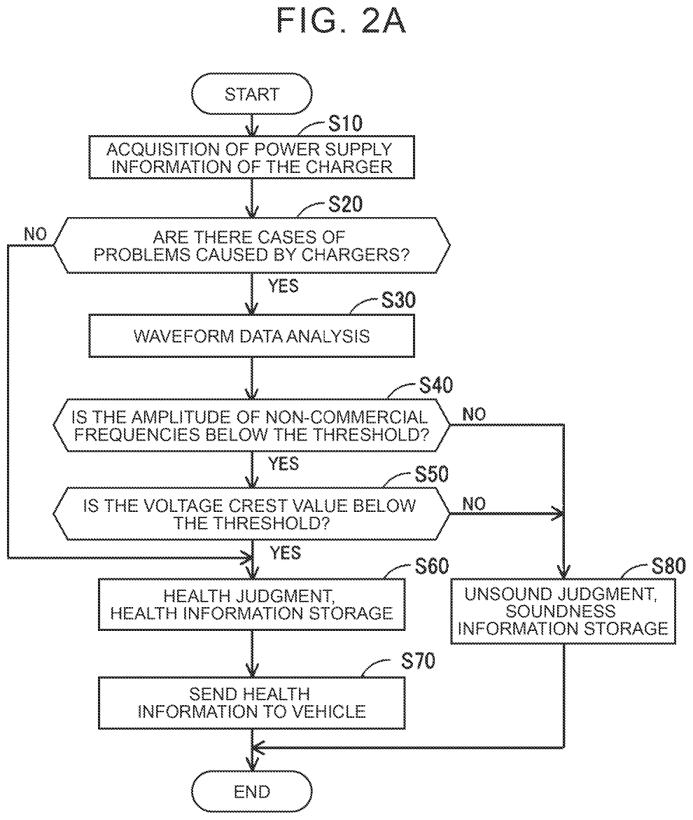

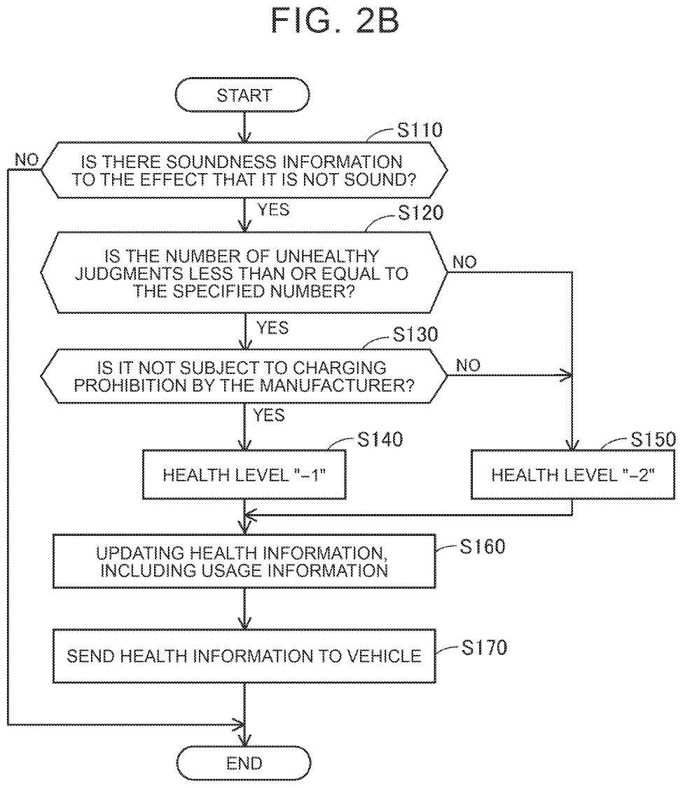

Next, the process of determining the soundness of the charger 70 and managing the soundness information of the charger 70 performed by the server 80 of the charging system 100 will be described with reference to FIGS. 2A and 2B. In these processes, when the vehicle 10 is connected to the charger 70 to charge the battery 12 from the charger 70, the power supply information of the charger 70 detected by the power receiving unit 30 is sent to the server 80 via the communication device 50, and executed when the server 80 receives the power supply information.

As shown in FIG. 2A, the server 80 monitors reception of power supply information of the charger from the vehicle 10, and when the server 80 acquires the power supply information of the charger 70 (S10), the server 80 acquires A determination is made as to whether or not the power supply information includes a failure case caused by the charger held by the server 80 in advance (S20). The power supply information from the vehicle 10 includes position information of the charger 70 and identification information of the vehicle 10.

When the power supply information does not include a failure case caused by the charger, the server 80 determines that the charger 70 is healthy without any failure, stores the health information of the charger 70 with the location information of the charger 70 in the memory of server 80 (S60), transmits the health information indicating that charger 70 is healthy to vehicle 10 (S70), and this process ends.

When the power supply information includes a failure case caused by the charger, the server 80 analyzes the waveform data included in the power supply information (S30) to determine whether the amplitude of frequencies other than the commercial frequency is equal to or less than the threshold (S40). When the amplitude of frequencies other than the commercial frequency exceeds the threshold, the server 80 determines that the charger 70 is unhealthy due to a problem caused by the charger, and sends the location information of the charger 70 and the health information of the charger 70 to the server 80 (S80), and the process ends.

Further, when the amplitude other than the commercial frequency is equal to or less than the threshold, the server 80 further determines whether or not the voltage crest value is equal to or less (S50). When the voltage peak value is exceeded, the server 80 determines that the charger 70 is unhealthy due to a problem caused by the charger, and stores the position information of the charger 70 and the health information of the charger 70 in the memory of the server 80 (S80), and terminate this process.

When the voltage crest value is equal to or less than the threshold, the server 80 determines that the charger 70 is sound without any trouble caused by the charger, and sends the position information of the charger 70 and the soundness information of the charger 70 to the server 80 (S60), the health information indicating that the charger 70 is healthy is transmitted to the vehicle 10 (S70), and this process ends.

Moreover, the server 80 performs the process shown in FIG. 2B and further determines the health level of the charger 70 when the health information indicating that the charger 70 is not healthy is stored.

As shown in FIG. 2B, the server 80 monitors generation of health information indicating that the charger is not healthy (S110). When the health information indicating that the charger is not healthy is not generated, the server 80 terminates this process and continues to monitor the generation of health information.

When the health information indicating that the charger 70 is not healthy occurs, the server 80 updates the past health information of the charger 70 based on the location information of the charger 70 included in the health information of the charger 70 by referring to the history, it is determined whether or not the number of times of determination as being unhealthy is equal to or less than a specified number of times (S120). When the number of determinations exceeds the specified number of times, the server 80 determines that the soundness of the charger 70 is “−2”, which is the level at which the use of the charger is recommended to be avoided (S150), the health information of the charger 70 is updated with the use information including avoidance of use of the charger 70 (S160), the health information with the use information is sent to the vehicle 10 (S170), and terminate this process.

When the number of determinations is equal to or less than the specified number of times, the server 80 determines whether the charger 70 falls under the charging prohibition target notified to the server 80 by the manufacturer of the vehicle 10 stored in advance in the memory of the server 80 (S130). When the charger 70 is subject to charging prohibition, the server 80 determines that the health of the charger 70 is “−2” (S150), and updates the usage information including avoidance of usage of the health information of the charger 70 to the use of the charger 70 (S160), transmits this health information to the user of the vehicle 10 (S170), and terminates this process.

When the charger 70 does not fall under the charging prohibition target, the server 80 notifies the user of the vehicle 10 that the health of the charger 70 has not deteriorated to the extent that avoidance of use of the charger is recommended (S140), the health information of the charger 70 is determined to be “−1”, which is a level at which attention is recommended, and the health information of the charger 70 is used to call attention to the use of the charger 70 (S160), transmits this health information to the user of the vehicle 10 (S170), and terminates the process.

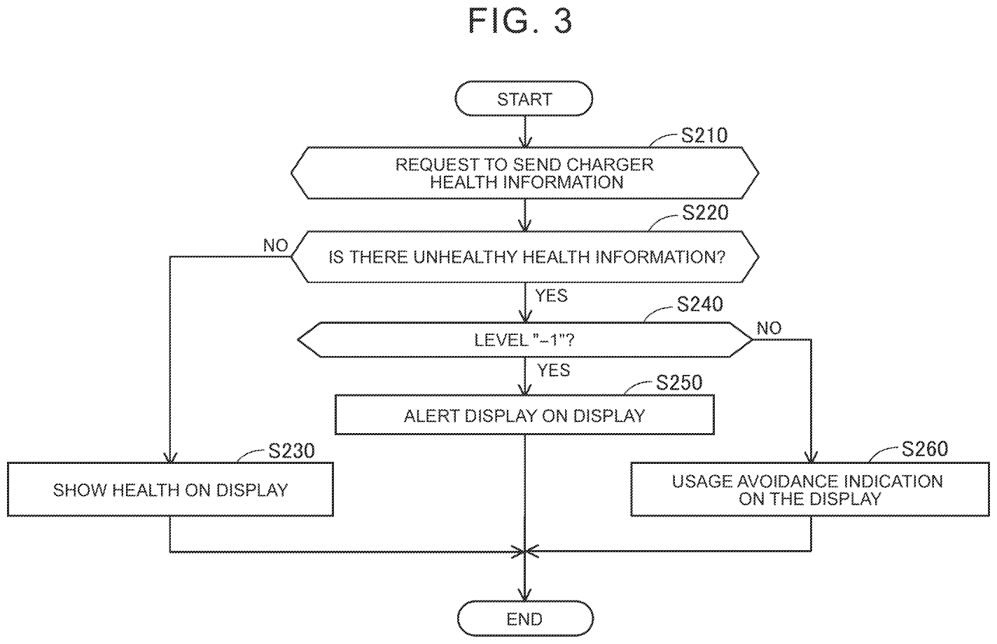

Next, the process of using the health information of the charger 70 performed by the vehicle 11, which is another vehicle of the charging system 100, will be described with reference to FIG. 3. This process is performed, for example, while vehicle 11 is running near charger 70 as a candidate charger for charging battery 12.

As shown in FIG. 3, the ECU 20 of the vehicle 11 requests the server 80 to transmit health information of the charger 70 via the communication device 50 (S210). The request for transmission here is a request for transmission of health information including past history and health level of the health information of charger 70.

The ECU 20 determines whether or not the received health information includes health information indicating that the charger 70 is not healthy (S220). When such health information is not included, the ECU 20 displays on the display of the navigation system or the like of the vehicle 11 that the charger 70 is healthy (S230), and terminates this process.

When the received health information indicating that the charger 70 is not healthy, the ECU 20 further refers to the health level of the charger 70 and determines whether the level is “−1” (S240). When the level is “−1”, the ECU 20 displays on the display of the navigation system or the like of the vehicle 11 that the use of the charger 70 is at the alert level healthiness (S250), and terminates this process.

When the level is not “−1”, the ECU 20 determines that the level is “−2”, and indicates on the display of the navigation system of the vehicle 11 that the use avoidance level of the charger 70 is healthy (S260), and terminate this process.

As described above, when server 80 acquires power supply information of charger 70 from vehicle 10, server 80 determines the soundness of charger 70 and generates and manages the soundness information of charger 70. In addition, when the server 80 generates the health information indicating that the charger 70 has a problem caused by the charger, the server 80 refers to the past health history of the charger 70 for the health of the charger 70 to determine the number of times the soundness is denied as a result of the determination, and further, the applicability of the charge-prohibited charger notified by the manufacturer of the vehicle 10, determine the level of soundness of the charger 70, and update the health information of the charger 70.

Further, vehicle 10 transmits power supply information of charger 70 to server 80 when charging from charger 70 is started and before the charging operation is started. Thereby, the server 80 is provided with the latest power supply information of the charger 70. Vehicle 10 will also be able to receive charger 70 health information from server 80. The user of the vehicle 10 can check the soundness of the charger 70 by using the soundness information of the charger 70, and avoid or suppress problems such as damage to the power receiving unit 30 of the vehicle 10, long charging time, and inability to charge, so that safe and reliable charging of the battery 12 is possible.

Furthermore, when the vehicle 11, which is another vehicle, selects the charger 70 as a charger candidate when the SOC drops, the vehicle 11 transmits a request for transmitting the health information of the charger 70 to the server 80, so that the health information of the charger 70 can be received from the server 80. Since the user of the vehicle 11 can obtain the health information of the charger 70 sufficiently before reaching the charger 70, the power receiving unit 30 of the vehicle 11 may be damaged, charging may take a long time, and charging may not be possible can be avoided or suppressed to efficiently charge the battery 12 with a safer and more reliable charger.

The collection and use of such health information applies equally to many vehicles and chargers.

As described above, according to the charging system 100 disclosed in the present specification, the user of the vehicle 10 or the like can acquire the soundness information of the charger 70 or the like, so safer and more reliable charging becomes possible. As a result, the user's convenience regarding the external charging is improved.

In the above description, the charging system 100 has been described, but according to the above embodiment, it can be said that it has the technical feature in which the vehicles 10 and 11 and the server 80 used in the present charging system 100 can also contribute to the charging system 100 and can be independent of each other.

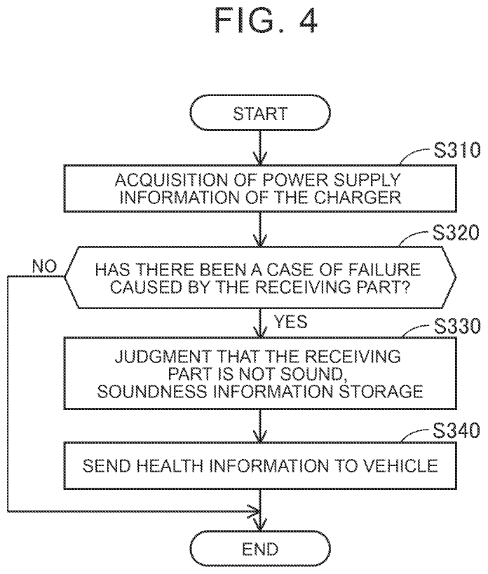

Further, in the above description, the determination of whether or not the charger 70 has a problem caused by the charger (for example, S40, S50) executed by the server 80 is an example, and the present disclosure is not limited to this. It can also be based on the overvoltage from the voltage value, the overcurrent from the current value, etc. included in the power supply information of the charger 70. For example, an overcurrent or the like detected in the power receiving unit 30 may be an indicator of malfunction in the power receiving unit 30. For example, the server 80 may execute the flow shown in FIG. 4 as a modification of FIG. 2A.

As shown in FIG. 4, the server 80 acquires the power supply information of the charger 70 (S310), and determines whether or not the power supply information includes a failure case caused by the power receiving unit 30 of the vehicle 10 (S320). When the power supply information does not include a failure case caused by the power receiving unit 30, such as overcurrent, the server 80 terminates this process.

When the power supply information includes a case of failure caused by the power receiving unit such as overcurrent, the server 80 determines that the power receiving unit 30 has a problem and is not sound, and sends the power receiving unit of the vehicle 10 together with the identification information of the vehicle 10. 30 is stored in the memory of server 80 (S330), the health information indicating that power receiving unit 30 is not healthy is transmitted to vehicle 10 (S340), and this process ends.

In the above description, to the vehicle 10 that has transmitted the power supply information of charger 70, the health information of charger 70 based on the power supply information is fed back to the vehicle 10 from server 80, but it is not limited. In the above description, the server 80 transmits the health information to the vehicle 10 or the like, but the present disclosure is not limited to this. Even though the health information is transmitted to the mobile terminal of the user such as the vehicle 10, the health information is provided to the user. In addition, the server 80 can widely provide general vehicle users with charger health information as a charger health map, a navigation system, or the like.

According to the above description, the present specification includes the following configurations.
(1) A charging system for a vehicle equipped with a battery, the charging system comprising:
a first vehicle and a second vehicle; and
a server, wherein:
the first vehicle acquires power supply information about a power supply status of power supplied to the first vehicle by at least one charger of a plurality of chargers disposed to charge the battery, and transmits the power supply information to the server; and
the server determines health of the at least one charger based on the power supply information received from the first vehicle, and provides health information about the health of the at least one charger to a user of the first vehicle or the second vehicle, or users of the first vehicle and the second vehicle.
(2) The system according to (1), wherein the health information includes location information of the at least one charger.
(3) The system according to (1) or (2), wherein the server determines a level of the health of the at least one charger based on the power supply information of the at least one charger.
(4) The system according to (3), wherein the server determines the level of the health of the at least one charger based on a history of the power supply information of the at least one charger.
(5) The system according to (3) or (4), wherein the server provides the health information including usage information about usage of the at least one charger to the user of the first vehicle or the second vehicle, or the users of the first vehicle and the second vehicle, based on the level of the health of the at least one charger.
(6) A vehicle comprising:
a battery that is able to be charged by a charger provided outside the vehicle; and
a sensor for detecting power supply information about a power supply status of power supplied by the charger to the vehicle,
wherein
the power supply information is transmitted to a server.
(7) The vehicle according to (6), wherein the server determines health of the charger based on the power supply information received from the vehicle, and provides health information about the health of the charger to a user of the vehicle or another vehicle, or users of the vehicle and the other vehicle.
(8) The vehicle according to (7), wherein the vehicle receives, from the server, health information about health of the other charger based on power supply information about the other charger received by the server from the other vehicle.
(9) A server that transmits and receives information to and from a first vehicle and a second vehicle,
each of the first vehicle and the second vehicle being a vehicle in which a battery is charged by a charger, wherein
the server
receives, from the first vehicle, power supply information about a power supply status of power supplied to the first vehicle by at least one charger that is able to charge the battery, determines health of the at least one charger based on the power supply information, and provides health information about the health of the at least one charger to a user of the first vehicle or the second vehicle, or users of the first vehicle and the second vehicle.

What is claimed is:

1. A charging system for a vehicle equipped with a battery, the charging system comprising:
a first vehicle and a second vehicle; and
a server, wherein:
the first vehicle acquires power supply information about a power supply status of power supplied to the first vehicle by at least one charger of a plurality of chargers disposed to charge the battery, and transmits the power supply information to the server; and
the server determines health of the at least one charger based on the power supply information received from the first vehicle, and provides health information about the health of the at least one charger to a user of the first vehicle or the second vehicle, or users of the first vehicle and the second vehicle.

2. The system according to claim 1, wherein the health information includes location information of the at least one charger.

3. The system according to claim 2, wherein the server determines a level of the health of the at least one charger based on the power supply information about the at least one charger.

4. The system according to claim 3, wherein the server determines the level of the health of the at least one charger based on a history of the power supply information about the at least one charger.

5. The system according to claim 4, wherein the server provides the health information including usage information about usage of the at least one charger to the user of the first vehicle or the second vehicle, or the users of the first vehicle and the second vehicle, based on the level of the health of the at least one charger.

6. A vehicle comprising:
a battery that is able to be charged by a charger provided outside the vehicle; and
a sensor for detecting power supply information about a power supply status of power supplied by the charger to the vehicle, wherein the power supply information is transmitted to a server.

7. The vehicle according to claim 6, wherein the server determines health of the charger based on the power supply information received from the vehicle, and provides health information about the health of the charger to a user of the vehicle or another vehicle, or users of the vehicle and the other vehicle.

8. The vehicle according to claim 7, wherein the vehicle receives, from the server, health information about health of the other charger based on power supply information about the other charger received by the server from the other vehicle.

9. A server that transmits and receives information to and from a first vehicle and a second vehicle, each of the first vehicle and the second vehicle being a vehicle in which a battery is charged by a charger, wherein the server receives, from the first vehicle, power supply information about a power supply status of power supplied to the first vehicle by at least one charger that is able to charge the battery, determines health of the at least one charger based on the power supply information, and provides health information about the health of the at least one charger to a user of the first vehicle or the second vehicle, or users of the first vehicle and the second vehicle.
